(19) United States
(12) Patent Application Publication
(10) Pub. No.: US 2007/0033284 A1
(43) Pub. Date: Feb. 8, 2007

(54) System server for data processing with multiple clients and a data processing method

(76) Inventors: Kwang Nam Gung, Seoul (KR); YunSeok Lee, Yonginsi (KR); NamHoon Byun, Yonginsi (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/390,492

(22) Filed: Mar. 27, 2006

(30) Foreign Application Priority Data
Aug. 2, 2005 (KR) 10-2005-0070793

(51) Int. Cl. G06F 15/16

(52) U.S. Cl. 709/227

(57) ABSTRACT

Disclosed is a system server for data processing between the server and more than one client connected via wired or wireless communication network and a data processing method. The system server includes a connecting module for establishing connection with a client and cutting off the connection, a data transmitting module for receiving and/or sending data from or to the client, a thread managing module for creating a thread and assigning the thread to the client, a session information database for storing an identifier of a session assigned to the client connected and information on a state of data which the client requests the server to process (“data to be processed”) being processed by the session, and a session managing module for monitoring the state of data processing and updating the information on the state of data processing stored in the session information database, the session managing module closing the session in case it is determined that data processing is not being performed by the session on the basis of the information on the state of data processing stored in the session information database.

### CROSS-REFERENCE TO RELATED APPLICATIONS

The present application claims priority to the Korean patent application No. 2005-70793 filed on Aug. 2, 2005, the contents of which are incorporated herein by reference in its entirety.

### BACKGROUND

1. Field

The present invention relates to a system server for data processing with multiple clients and a data processing method. More particularly, the present invention relates to a system server and a data processing method for processing data stably and efficiently and monitoring a state of data processing of each session on real-time in order to close inactive sessions.

2. Description of the Related Art

Recently, many enterprises introduce RTE (Real Time Enterprise) systems for managing outside business functions real time as well as inside business functions. In other words, the RTE system, which enables outside business functions of an enterprise of its business partners and customers to be managed real time, has been introduced in order to improve efficiency of business management of the enterprise.

However, in case of constructing a data processing system such as the RTE system on the basis of a wireless communication network such as CDMA, wireless LAN, and the like, the data processing system may lack data format matching, stability and reliability of data processing due to the limitations of the present IT infrastructure and interface among different systems. Especially, the system may stop sometimes when a large number of users connects to the system at the same time.

Further, it is very important for the RTE system to monitor the status of client sessions and perform data processing required by clients efficiently and stably.

### SUMMARY

Therefore, one aspect of the present invention provides a system server for data processing with multiple clients and a data processing method, which are capable of making use of system resources efficiently by monitoring a state of data processing of each of client sessions and managing inactive sessions.

Further, another aspect of the present invention provides an improved management of simultaneous connections with multiple clients and overlapped data processing requirements for efficient and stable data processing.

According to an aspect of the present invention, a system server for data processing between the server and more than one client connected via wired or wireless communication network is provided, wherein the system server includes a connecting module for establishing connection with a client and cutting off the connection, a data transmitting module for receiving and/or sending data from or to the client, a thread managing module for creating a thread and assigning the thread to the client, a session information database for storing an identifier of a session assigned to the client connected and information on a state of data which the client requests the server to process (“data to be processed”) being processed by the session, and a session managing module for monitoring the state of data processing and updating the information on the state of data processing stored in the session information database, the session managing module closing the session in case it is determined that data processing is not being performed by the session on the basis of the information on the state of data processing stored in the session information database.

According to another aspect of the present invention, a data processing method between a server and more than one client connected via wired or wireless communication network is provided, wherein the method includes steps of (1) establishing connection with a client or cutting off the connection, (2) receiving and/or sending data from or to the client, (3) creating a thread and assigning the thread to the client, (4) storing an identifier of a session assigned to the client and information on a state of data which the client requests the server to process (“data to be processed”) being processed by the session in a session information database, (5) monitoring the state of data processing and updating the information on the state of data processing stored in the session information database, (6) determining whether or not data processing is being performed by the session on the basis of the information on the state of data processing; and (7) closing the session in case it is determined that data processing is not being performed by the session in the step (6).

The foregoing summary does not describe all the features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a schematic block diagram showing a data processing system 200 according to an embodiment of the present invention.

FIG. 2 is a block diagram showing a first embodiment of the configuration of the server 100 of the data processing system 200 according to the present invention.

FIG. 3 is a block diagram showing a second embodiment of the configuration of the server 100 of the data processing system 200 according to the present invention.

FIG. 4 is a flowchart showing a process flow on the server 100 side according to an embodiment of the present invention of the server 100.

FIG. 5 is a flowchart showing a process flow of on a client 10 side according to an embodiment of the present invention.

### DETAILED DESCRIPTION EMBODIMENTS

The invention will now be described in terms of its embodiments, which do not intend to limit the scope of the present invention, but exemplify the invention. All of the features and the combinations thereof described in the embodiment are not necessarily essential to the invention.

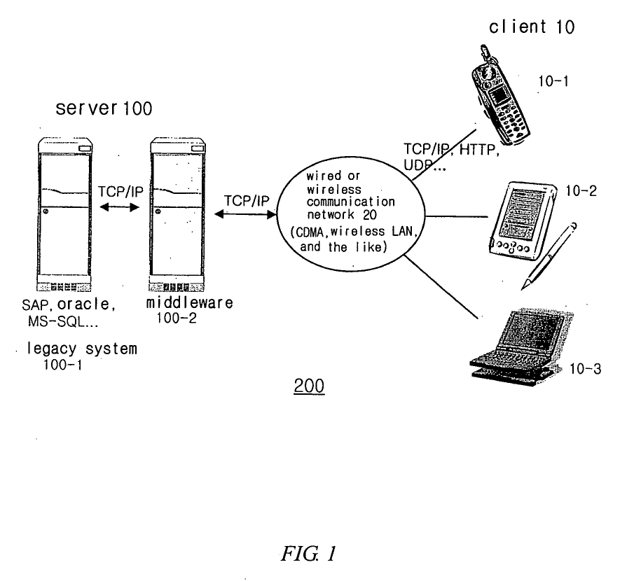

FIG. 1 is a schematic block diagram showing a data processing system 200 according to one embodiment of the present invention. The data processing system 200 includes a server 100, clients 10-1, 10-2, and 10-3 (hereinafter, referred to “10”), and a wired or wireless communication network 20, which connects the server 100 and the clients 10. According to the present figure, the server 100 comprises a legacy system 100-1 including DBMS(DataBase Management System) such as SAP, oracle, MS-SQL, etc, and a middleware 100-2 which interfaces the legacy system 100-1 and many different clients 10.

Each of elements of the system server 100 may be realized by constructing a dedicated piece of hardware or using software although not limited thereto.

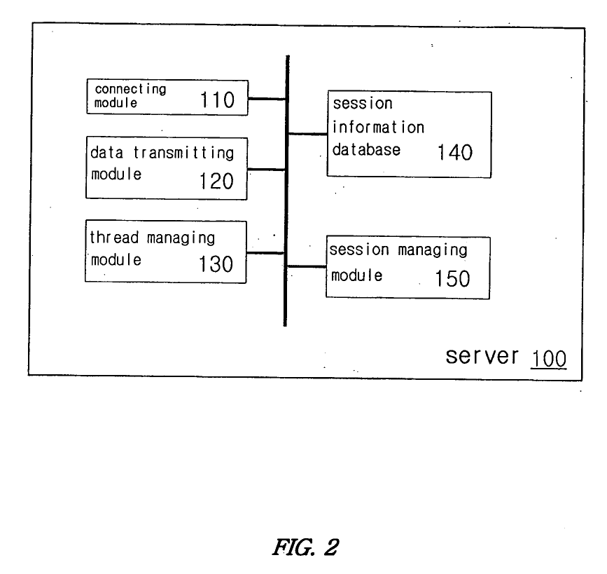

FIG. 2 is a block diagram showing one embodiment of the configuration of the server 100 of the data processing system 200. The server 100 includes a connecting module 110, a data transmitting module 120, a thread managing module 130, a session information database 140, and a session managing module 150. The modules 110 to 150 are interconnected via a bus or any other proper electrical connections.

The connecting module 110 establishes or cuts off connection between the client 10 and the server 100. Establishing and cutting off connections may be performed by an instruction or request from the client 10 or the server 100, or automatically under predetermined conditions. For example, it is desirable that the connecting module 110 establishes connection according to a request for connection from the client 10 and cuts off connection in case data processing between the server 100 and the client 10 cannot be performed any more or the data processing is completed without any requests or instructions. In particular, in order to reduce data traffic fees, it is desirable that connection is automatically cut off when the server 100 receives a commit message from the client 10.

The data transmitting module 120 receives/sends data from/to the client 10.

The thread managing module 130 creates threads and assigns the threads to the clients 10. When a client 10 tries to connect to the server 100, a listener requests a thread in a thread pool to be assigned to the client 10. At this time, in case there is a spare thread which is available in the thread pool, the thread managing module 130 assigns the spare thread to the client 10. In case there is no spare thread in the thread pool, the thread managing module 130 checks the number of simultaneous connections. If the number of connections does not exceed the maximum allowable simultaneous connections, the thread managing module 130 creates a new thread and assigns the thread to the client 10. Otherwise, the client waits until a thread to be assigned exists.

The session information database 140 stores a session identifier (ID) given to each of the clients 10 which are being connected with the server 100. The session information database 140 further stores the state of data processing requested by the client as session information. Here, the state of data processing is information such as “process standby” before the data processing is not started yet, “on process” when the data processing is being performed, or “process completion” after the data processing is completed, for example. It is desirable that the session ID is set uniquely for each user. By this, it is possible to catch what kind of equipment the user makes use of to connect to the server 100.

The session managing module 150 updates the state of data processing stored in the session information database 140, i.e., the session information, and classifies each session according to the session information. For example, the session managing module 150 changes session information of a session stored in the session information database 140 from “process standby” to “on process” when data processing is started by the session and stores the updated session information in the session information database 140. It is desirable that the session managing module 150 observes the state of data processing of each session continuously and updates the session information for the session real time.

Further, the session managing module 150 closes a session when it is determined that data processing is not being performed by the session on the basis of the state of data processing of the session. For example, the session managing module 150 may measure or obtain the time taken from the time when a thread is assigned to a client 10 to the time when a state of data processing of the session for the client becomes “process completion” and close the session in case the time obtained exceeds a predetermined value. Alternatively, the session managing module 150 may measure or obtain the time taken for session information of a session to be updated. In this case, if the session information is not updated even after a predetermined time period passes, the session managing module 150 regards the session as inactive and closes the session. In the following, an “inactive” session means a session in which data processing is not being performed. As described above, resources of the server 100 can be effectively used by determining whether or not sessions are inactive on the basis of session information (i.e., the state of data processing of the sessions) and closing inactive sessions.

In case a session is closed before data processing is concluded, the server 100 may send to the client 10 a message indicating that the data processing is not concluded and the client 10 may save data which has not been processed by the server 100 and ask the server 100 to process the data later. More specifically, in case the session managing module 150 determines that data processing is not performed in a session on the basis of the session information of the session, the server 100 closes the session and sends the client 10 a message for indicating that data transmitted from the client 10 has not been processed by the server 100. The client 10 then stores the data which has not been processed in its local memory and asks the server 100 to perform processing of the data once more later. By this, it is possible to prevent data to be processed from being left out.

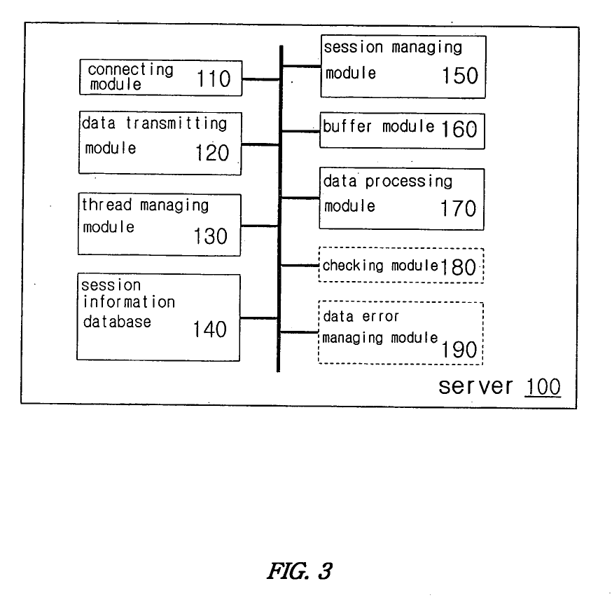

FIG. 3 is a block diagram showing another embodiment of the configuration of the server 100 of the data processing system 200. Since configuration and functions of elements which use the same reference numerals as those of FIG. 1 are similar with those of elements of the first embodiment, only differences from the first embodiment will be described in the following. Specifically in FIG. 3, a buffer module 160 and a data processing module 170 are added to the configuration and features of FIG. 1.

According to the present embodiment, when session information stored in the session information database 140 for some sessions is “process standby”, the session managing module 150 delivers data to be processed in the sessions to the buffer module 160, sequentially, and the data are stored in the buffer module 160. The data stored in the buffer module 160 are delivered to the data processing module 170 sequentially. In this embodiment, a thread, which is assigned to a client when connection between the client and the server is established, takes charge of data transmission between the client and the server but data processing is performed by the data processing module. In order to improve performance of data processing, it is desirable that the data processing module 170 includes a separate thread pool.

By placing the buffer module 160 between the connecting module 110 and the data processing module 170 as described above, even if data traffic congestion happens and thus requests for data processing are poured in from clients at a moment, data are stacked in the buffer module 160 and processed sequentially by the data processing module 170. Therefore, even if processing by the legacy system 100-1 is delayed, it is possible to maintain performance of the gateway.

In embodiments, the server 100 may further include either or both of a checking module 180 and a data error managing module 190. The checking module 180 checks whether data that is received by the client 10 and is to be processed is corrupt.

The data error managing module 190 includes a storing device for storing data to be processed in case the data processing module 170 has completed data processing but an error occurs immediately before or while the result of the data processing is sent to the client 10. Further, the storing device of the data error managing module 190 stores the result of the data processing.

In case the checking module 180 determines that the data to be processed is corrupt, an error message is sent to the client 10. Then, the thread for the client 10 is return to the thread pool and the session is closed. In this case, it is desirable that data which have not been processed are stored in a local memory or database of the client 10 and will be batch-processed later. By this, it is possible to prevent data which the client 10 has asked the server 100 to process from not being processed and being left out.

In case the checking module 180 determines that the data to be processed is not corrupt, the checking module 180 determines whether the data error managing module 190 stores a result of processing data which is the same as the data to be processed. Specifically, for example, each client 10 assigns an identifier (ID) to data to be processed when the transmitting the data to be processed to the server 100, and the checking module 180 compares the ID of the data to be processed and IDs of data stored in the data error managing module 190 in order to determine whether any data to be processed the same ID as that of the corrupt data. In the present example, the data error managing module 190 may store IDs of data and/or the data. In case the data error managing module 190 stores a result of data processing which is the same as the data to be processed, the result stored in the data error managing module 190 is sent to the client 10 as a result of processing the data to be processed.

As above, in case data has been already processed but an error occurs immediately before or while the result of processing the data is sent to the client, the server 100 stores the data and the result of processing the data separately. Thus, the server 100 can use the data processing result when the client 10 asks it to process the same data. Consequently, it is possible to prevent data processing from being duplicated.

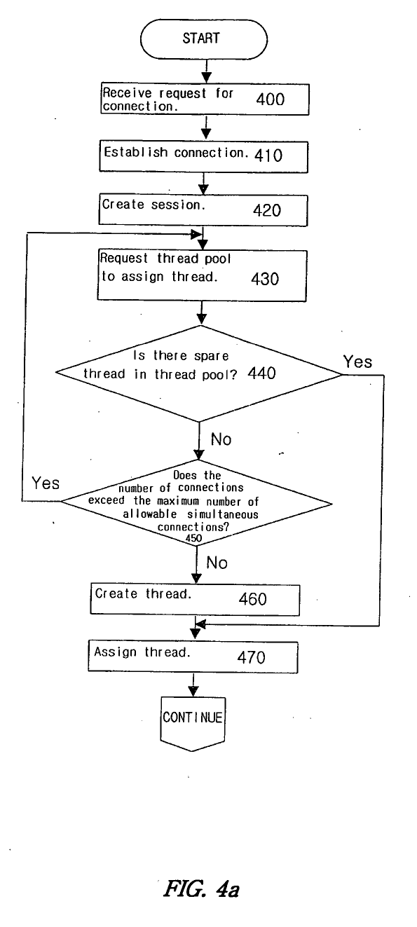

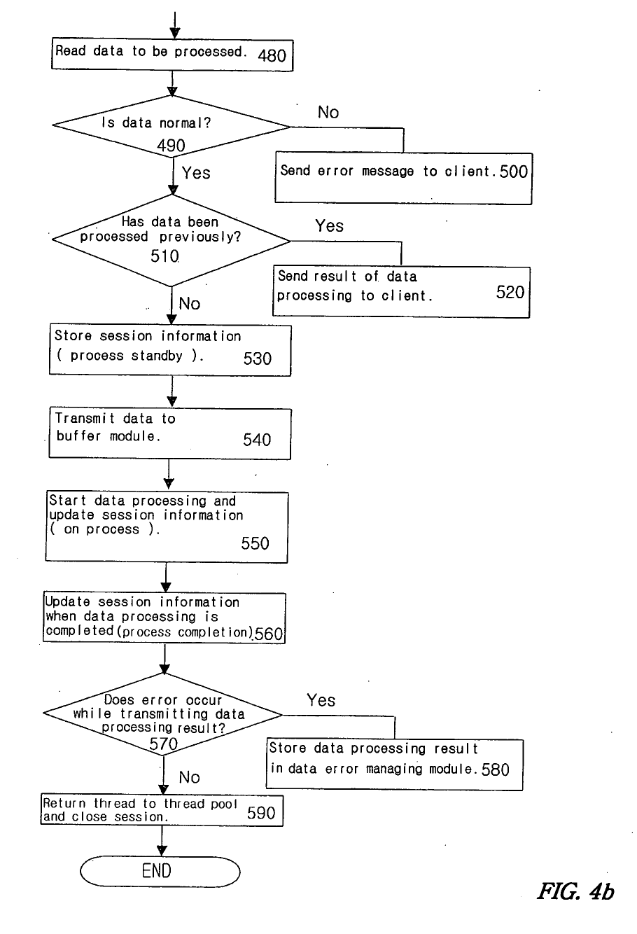

FIG. 4 is a flowchart showing a process flow on the server 100 side according to an embodiment of the present invention. FIG. 4A shows a flow from the step of establishing a connection between a client 10 and the server 100 to start the procedure to the step of assigning a thread to the client 10. When a request for connection is received from the client 10 (S400), the connecting module 110 establishes connection between the client 10 and the server 100 (S410) and the session managing module 150 creates a session for the client 10 (S420). At this time, by assigning a unique session identifier to each user, the server 100 may recognize what kind of equipment the user makes use of to connect to the server 100.

Then, a thread is requested (S430), the thread managing module 130 determines whether or not there is a spare thread which is standby in the thread pool (S440). In case there is a spare thread in the thread pool (S440: Yes), the spare thread is assigned to the client 10. In case there is no spare thread (S440: No), the thread managing module 130 checks the number of simultaneous connections (S450). If the number of connections is smaller than the maximum number of allowable simultaneous connections (S450: No), the thread managing module 130 creates a thread (S460) and assigns the thread to the client 10 (S470). If the number of connections has reached the maximum allowable simultaneous connections (S450: Yes), the client waits until a thread is available for assignment.

After a thread is assigned to the client 10, the data transmitting module 120 reads data to be processed which the client 10 requests the server 10 to process (S480) as shown in FIG. 4B. Then, the checking module 180 determines whether or not the data to be processed is corrupt (S490). In case the data to be processed is corrupt (S490: No), an error message is sent to the client 10 and the procedure is finished (S500). In this case, it is desirable that the client 10 stores the data to be processed in its local database, as described above.

In case the data to be processed is not corrupt and normal (S490: Yes), it is determined whether or not the data error managing module 190 stores data which is the same as the data to be processed (S510). As described above, each client 10 may assign an identifier (ID) to data to be processed when the client 10 sends the data to be processed the server 100 and the ID of the data to be processed may be compared against the IDs of data stored in the data error managing module 190 in order to determine whether or not there is data of which ID is the same as that of the data to be processed in the data error managing module 190. In case the data error managing module 190 stores data of which ID is the same as that of the data to be processed (S510: Yes), the data error managing module 190 sends the result of processing the data which is stored therein to the client 10 (S520). When the result is sent normally to the client 10, the procedure is finished.

In case the data error managing module 190 does not store data of which ID is the same as that of the data to be processed (S510: No), data processing is started. Prior to start of data processing, “process standby” is stored in the session information database 140 as session information of the client 10 (S530). Then, the data to be processed is stored in the buffer module 160 (S540) and transferred to the data processing module 170 sequentially. By storing data to be processed before data processing, it is possible to maintain performance of the gateway even if process of the legacy system is delayed.

When data processing is started by the data processing module 170, the session information of the client 10 is updated to “on process” (S550). When the data processing is completed, the session information of the client 10 is updated to “process completion” (S560).

Once the data processing is completed, the result is sent to the client 10 who has requested the data processing. In case the result is transferred without an error (S570: No), the client 10 sends a commit message to the server 100. When the server 100 receives the commit message, the thread which has been assigned to the client 10 is return to the thread pool and the session for the client 10 is closed (S590). Thus, the procedure is finished.

In case an error occurs while the result is being transferred (S570: Yes), the result of data processing is stored in the data error managing module 190 together with the data (S580) and the procedure is finished.

Further, according to embodiments the present invention, the state of data processing of each session is monitored and a session in which data processing is not performed is closed. The state of data processing is monitored substantially continuously by the session managing module 150 connected with the thread managing module 130, the buffer module 160, the data processing module 170, and the like. More specifically, for example, at least one of the time taken from when a thread is assigned to when data processing is started, the time from when the data processing is started to when the data processing is completed, and the like, is measured or obtained for each session. In case the time exceeds a predetermined reference time, the session is determined to be inactive and will be closed. Thus, it is possible to prevent system resources from being wasted due to inactive sessions.

In case data processing is not completed but the session is closed, the server 100 desirably sends a message informing the client 10 that data processing is not completed. Receiving the message, the client 10 stores the data which has not been processed in its local database and makes the data batch-processed later. Thus, it is possible to prevent data to be processed from being unprocessed and from being left out.

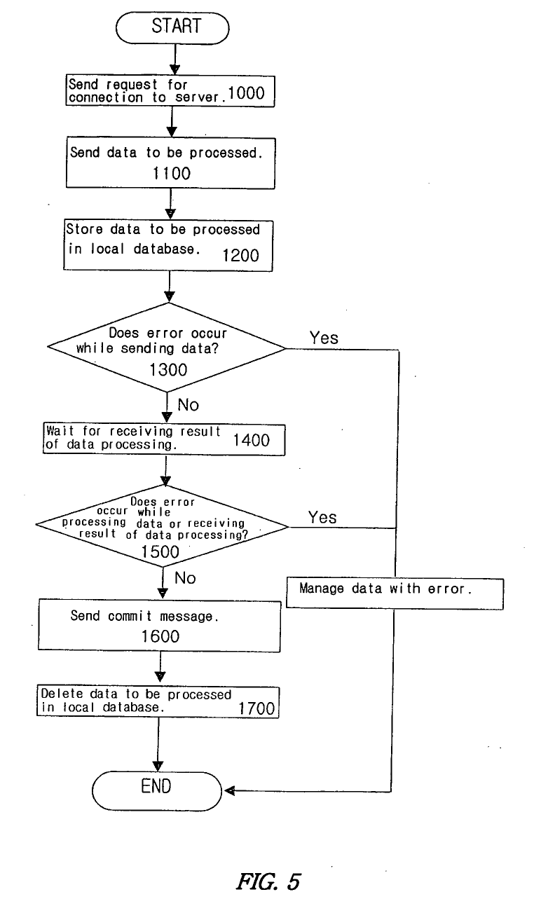

FIG. 5 a flowchart showing a process flow on the client 10 side according to an embodiment of the present invention.

The client 10 sends a request for connection to the server 100 (S1000). In case the connection is accomplished, the client 10 sends data to be processed to the server 100 (S1100) and stores the data to be processed in the local database (S1200). In case the data to be processed is not normally transmitted to the server 100 (S1300: Yes), the data to be processed will be batch-processed later.

In case the data to be processed is normally transmitted to the server 100 (S1300: No), the client 10 waits for receiving the result of processing the data (S1400). If the client 10 receives a message informing that data processing cannot not be performed by the session for the client 10 or an error occurs before or while the result of processing the data is being sent to the client 10 (S1500: Yes), the client 10 may make the data batch-processed later.

If the result of processing the data is normally received (S1500: No), the client 10 sends a commit message to the server 100 (S1600) and deletes the data to be processed which has been stored in the local database (S1700). Thus, the procedure is finished.

As described above, the server according to an embodiment of the present invention checks the state of data processing of each session and closes a session which is determined to be inactive on the basis of the state of data processing of the session. Thus, even in case a plurality of users are connected with the server 100 at the same time, it is possible to prevent system resources from being wasted due to inactive sessions.

Further, it is possible to prevent data from not being processed and being left out or prevent data processing from being duplicated.

Although the present invention has been described by way of exemplary embodiments, it should be understood that those skilled in the art may be able to make many changes and substitutions without departing from the spirit and the scope of the present invention which is defined only by the appended claims.

1. A system server for data processing between said server and more than one client connected via wired or wireless communication network, the system server comprising:
a connecting module for establishing connection with a client and cutting off said connection;
a data transmitting module for receiving and/or sending data from or to said client;
a thread managing module for creating a thread and assigning said thread to said client;
a session information database for storing an identifier of a session assigned to said client and information on a state of data which said client requests said server to process (“data to be processed”) being processed by said session; and
a session managing module for monitoring said state of data processing and updating said information on said state of data processing stored in said session information database, said session managing module closing said session in case it is determined that data processing is not being performed by said session on the basis of said information on said state of data processing stored in said session information database.

2. The system server as claimed in claim 1, wherein said session managing module closes said session in case said information on said state of data processing of said session is not updated for a predetermined period.

3. The system server as claimed in claim 1, wherein said session managing module closes said session in case data processing is not started by said session for a predetermined period after said thread is assigned.

4. The system server as claimed in claim 1, wherein said session information database stores one of process standby, on process, and process completion as said information on said state of data processing.

5. The system server as claimed in claim 1, wherein said session identifier is unique to each user.

6. The system server as claimed in claim 1, further comprising a checking module for checking whether or not said data to be processed transmitted by said client is corrupt prior to data processing and sending an error message to said client in case said data to be processed is corrupt.

7. The system server as claimed in claim 6, further comprising a data error managing module for storing a result of processing data to be processed in case said data to be processed has been processed but an error occurs while said result is being sent to said client, wherein said checking module further checks whether or not said data error managing module stores a result of processing data which is the same as said data to be processed prior to data processing, and in case it is determined that said result is stored in said data error managing module, said data transmitting module sends said result to said client.

8. The system server as claimed in claim 1, further comprising:
a buffer module for storing data to be processed sequentially; and
a data processing module for performing data processing of said data to be processed transferred from said buffer module.

9. A data processing method in a system communicating with one or more clients, the method comprising:
(1) establishing connection with a client;
(2) receiving data from said client;
(3) creating a thread and assigning said thread to said client;
(4) storing an identifier of a session assigned to said client and information on a state of data which said client requests said server to process (“data to be processed”) being processed by said session in a session information database;
(5) monitoring said state of data processing and updating said information on said state of data processing stored in said session information database;
(6) determining whether or not data processing is being performed by said session on the basis of said information on said state of data processing; and
(7) closing said session in case it is determined that data processing is not being performed by said session in said step (6).

10. The data processing method as claimed in claim 9, wherein the time taken for said session to perform data processing is measured and said measured time is compared with a predetermined period, and in case said measured time is larger than said predetermined period as a result of said comparison, it is determined that data processing is not being performed by said session in said step (6).

11. The data processing method as claimed in claim 9, further comprising a step (8) of sending said client a result of data processing in case it is determined that data processing is normally completed by said session and closing said session.

12. The data processing method as claimed in claim 11, further comprising a step (8-1) of storing said result of data processing in a storing device in case an error occurs while said result of data processing is being sent to said client.

13. The data processing method as claimed in claim 12, further comprising:
(2-1) checking whether or not said data to be processed received from said client is corrupt prior to data processing; and
(2-2) checking whether or not said storing device stores a result of processing said data to be processed prior to data processing in case it is determined that said data to be processed is not corrupt in said step (2-1), wherein in case it is determined that said data to be processed is corrupt in said step (2-1), an error message is sent to said client, and in case said storing device stores a result of processing said data to be processed, said result stored in said storing device is sent to said client.

14. The data processing method as claimed in claim 9, wherein said session information database stores one of process standby, on process, and process completion as said information on said state of data processing in said step (4).

15. The data processing method as claimed in claim 14, further comprising a step (4-1) of, in case said state of data processing of said session is process standby, storing said data to be processed in a buffer sequentially.

16. The data processing method as claimed in claim 9, wherein said session identifier is unique to each user.
